(19) United States
(12) Patent Application Publication
(10) Pub. No.: US 2017/0101772 A1
(43) Pub. Date: Apr. 13, 2017

(54) INSULATION DEVICE

(71) Applicants: RANDALL L. OLSON, MOUNT VERNON, IL (US); BARRY SMOOT, MARION, IL (US)

(72) Inventors: RANDALL L. OLSON, MOUNT VERNON, IL (US); BARRY SMOOT, MARION, IL (US)

(21) Appl. No.: 14/877,380

(22) Filed: Oct. 7, 2015

(51) Int. Cl. E04B 1/76; E04B 1/66; B32B 27/32; B32B 7/06; B32B 27/06; E04B 1/78; E06B 7/16

(52) U.S. Cl. CPC E04B 1/76; E04B 1/78; E04B 1/66; E06B 7/16; B32B 7/06; B32B 27/065; B32B 27/32; B32B 2307/304

(57) ABSTRACT

An insulation device having an insulating foam disposed on a static cling sheet that allows the insulation device to be applied to the interior surface a typical window to provide thermal protection against heat loss wherein the device can be proved in either sheet or roll format to allow an installer to easily and quickly trim the insulation device to fit any portion of a window.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

During the last few years, reductions of energy consumption and energy conservation have been two primary goals of virtually every family and business in the United States. Achievement of those goals has affected everything from the design of more fuel efficient automobiles to the basic design of family homes and skyscraper business buildings.

In addition to the revisions to the basic design standards to achieve energy conservation, there have been tremendous efforts to generate materials and devices that can be added to pre-existing homes and business buildings that can convert those structures to more energy efficient systems. While may of those materials and devices can help reduce certain types of energy consumption, most of those materials and devices are not quickly or easily incorporated into preexisting structures. Sometimes the cost of retrofitting an existing structure to incorporate certain types of energy conserving materials or devices can be extremely expensive. In other situations, the effort of incorporation of those materials and devices can be greater than the effort to originally construct certain structures. As a result, many structures remain energy inefficient and cost the owner much more than it should to heat or cool those structures.

Various devices can be found that are generally capable of providing some assistance in reducing the energy costs of an energy inefficient structure. For example, addition of thermal insulation into the walls of a structure can result in some reduction of energy costs. Addition of that material into the attic space of a structure can also help keep a structure cooler in the summer and warmer in the winter. The addition of those insulating materials into the walls and ceilings of structures can also provide some reduction in thermal losses around light witches and doors.

While each of those types of structure modifications can result in better energy conservation, there remains one element of a structure that can be very difficult to modify to reduce energy costs. That element is the window. Currently there are only two primary methods of increasing the energy efficiency of a window in a preexisting structure. First, the entire window itself can be removed from the structure and replaced with a window that incorporates better thermal protection through the use of multiple panes of glass, better insulating glass panes, or by the introduction of either a vacuum between the multiple panes or the introduction of a thermally insulating gas between the panes. The second and sometimes most predominant method of reducing energy losses around a window is the application of a very thin plastic material around the window frame or the installation of complicated and sometimes heavy insulating frames to the frame of the window. In the case of the thin plastic material the energy costs reductions are based almost exclusively on the prevention of wind from passing through cracks and openings around the window frame or the window components. The plastic material itself provides no significant thermal protection. The plastic sheets for such installations are also normally quite thin are subject to puncture damage. In the case of large heavy insulating frames, the costs and efforts expended in installing such devices onto preexisting windows can be prohibitive.

In view of the above, it would be very useful and desirable to have an insulation device that is relatively inexpensive and that can be quickly and easily installed—particularly into preexisting structures such as individual family homes.

### SUMMARY OF THE INVENTION

This section provides a general summary of the disclosure, and is not a comprehensive disclosure of its full scope or all of its features.

It is a common for people to experience cold windows and heat loss in the winter time. People want to be comfortable in their home during winter without having to raise their thermostat and spend additional money on utilities, expensive window coverings, or new windows. Embodiments of the present invention insulate the window glass of the home by reducing heat loss due to conduction, convection, and radiant transfer. Certain embodiments of the present invention address that problem by application of a new method of insulating windows that includes applying some embodiments of the present invention directly to window glass using static cling material. That method significantly reduces heat loss through the window glass and keeps the surface temperature of the glass warmer which results in greater comfort within the home. Testing has shown that use of certain embodiments of the present invention have revealed when using infrared thermal imaging technology that use of these embodiments can result in lowering glass surface temperature when compared to the same glass surface that does not include any of these embodiments. By reducing heat loss, the HVAC unit for that structure will very likely not need to run as often and utility bills can be more stable.

It is also noted that certain embodiments of the present invention result in an insulation device that is more affordable, easily to apply, easy to trim, and can be reusable. It can be supplied in roll or sheet format. There is no adhesive required and there is no need for any special, expensive tools for installation. Additionally, certain embodiments of the present invention work well on single pane windows, double pane windows, storm doors, and sliding glass doors. Because the materials disclosed in the present embodiments include an opaque foam material, the product permits daylight to fill the room, thus not creating a “blackout” effect that result from the use of other devices such as shades, curtains, blinds, or bulky drapes.

The embodiments disclosed herein also offer a capability not available from standard solar window film or bulky plastic tape-on coverings that can often only be used one time and then thrown away after winter. More specifically, embodiments of the present invention can be installed onto the glass of a window and then later removed for re-use on the same or different window. This reusability significantly enhances the usefulness of these embodiments.

Therefore, in accordance with the various embodiments of the present invention, this invention relates to an insulation device that can be easily applied to a preexisting window element of a structure to provide a significant amount of thermal protection against seasonal temperature variations. Further areas of applicability will become apparent from the description provided herein. The description and specific examples in this summary are intended for purposes of illustration only and are not intended to limit the scope or the claims of the present disclosure.

### DESCRIPTION OF THE DRAWINGS

In the accompanying drawings which form part of the specification:

FIG. 1 is a perspective view of a typical window in which one embodiment of the present invention has been installed;

FIG. 2 is an exploded section view through one embodiment of the present invention; and

FIG. 3 shows a view of how the removable protective sheet is removed before installation of one embodiment of the present invention.

Corresponding reference numerals indicate corresponding steps or parts throughout the several figures of the drawings.

While specific embodiments of the present invention are illustrated in the above referenced drawings and in the following description, it is understood that the embodiments shown are merely some examples of various preferred embodiments and are offered for the purpose of illustration only, and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE PREFERRED EMBODIMENT OF THE INVENTION

In the following description, numerous specific details are set forth such as examples of some preferred embodiments, specific components, devices, and methods, in order to provide a thorough understanding of embodiments of the present disclosure. It will be apparent to a person of ordinary skill in the art that these specific details need not be exclusively employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

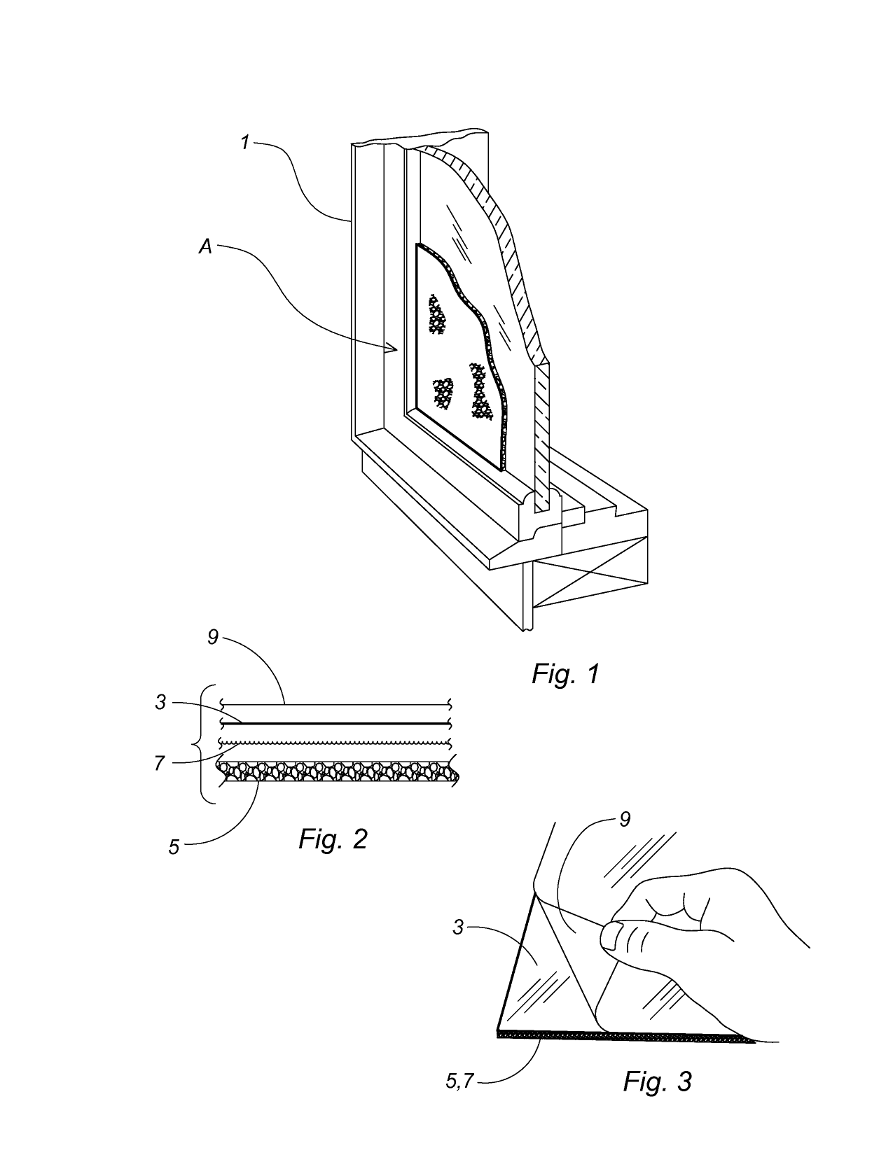

At least one preferred embodiment of the present invention is illustrated in the drawings and figures contained within this specification. More specifically, some preferred embodiments of the present invention are generally disclosed and described in FIGS. 1-3.

Referring now to FIG. 1, one embodiment of the present invention is shown after installation onto a typical residential window. More specifically, the Insulation Device A has been applied to an interior surface 2 of the window 1. It is understood that in this embodiment the Insulation Device A is installed such that the foam element 5 of the Insulation Device faces away from the inside the interior surface 2 of the window 1 and that a static cling sheet 3 (FIG. 2) is in direct contact with the interior surface 2 (FIG. 1) of the window and faces outwardly toward the outside region of the building in which the window has been installed.

FIG. 2 shows the general construction of this embodiment of the Insulation Device A. In this embodiment a foam element 5 is disposed on the static cling sheet 3 and held in place thereon by an adhesive 7 placed between the foam element and the static cling sheet. To protect the static cling sheet 3 from potential damage during shipping, storage, and installation of the Insulation Device A, a removable protective sheet 9 is disposed on an outer surface 4 of the static cling sheet. It will be appreciated that in the present embodiment, the removable protective sheet 9 does not have any specific adhesive material disposed between the static cling sheet 3 and the removable protective sheet 9 and that, instead, the same general method of static connection between the removable protective sheet and the static cling sheet keeps the removable protective sheet in place on the static cling sheet until the removable protective sheet is removed during installation. In alternative embodiments, an adhesive that does not leave substantial residue can be used to hold the removable protective sheet 9 from the static cling sheet 3. This is to say that in this alternative embodiment the adhesive does not leave residue that substantially affects the ability of the static cling sheet 3 to remain statically adhered to the interior surface 2 of the window 1 (FIG. 1) after the removable protective sheet 9 has been removed and the Insulation Device A has been fully installed.

The cling sheet 3 (FIG. 2) of the present embodiment is made from a static cling UV window film that is well-known in the industry. For example, at least one embodiment of the present invention can use a static cling polyvinylchloride (PVC) film that is ultraviolet (UV) UV protected with a Visible Light Transmission (VLT) of at least 25%. The film in this embodiment has a thickness ranging between about 0.14 mm and about 0.28 mm.

The foam element 5 of the present embodiment is made from polyethylene foam. For example, at least one embodiment of the present invention can use polyethylene cross-linked white foam that has a thickness of at least 3.0 mm while having a density of between about 2.0 lb to about 3.0 lb per cubic foot and a thermal transmittance (U-factor) value of between about 0.5 and about 1.0.

The removable protective sheet 9 in the current embodiment is made from Oriented Polypropylene Film with a thickness of between about 10 microns and about 40 microns. Because the purpose of the removable protective sheet 9 is to prevent potential damage to the surface of the static cling sheet 3, any type of material can be used as the removable protective sheet as long as the material selected can be disposed on the surface of the cling sheet during storage and shipping until the removable protective sheet is removed just before application of the Insulation Device A to the interior surface 2 (FIG. 1) of the window 1.

The adhesive 7 (FIG. 2) can be any type of adhesive material as long as material selected can be applied with a sprayer or a roller and does not damage the foam element 5 or the static cling sheet 3. In some embodiments the adhesive can also be a water resistant material to prevent certain deterioration of the any component of the Insulation Device A over extended periods of time. in a preferred embodiment, the adhesive 7 is clear polymer adhesive that can be applied by a sprayer or a roller.

Installation of the Insulation Device A includes the removal of the removable protective sheet 9 (FIG. 3) just before the Insulation Device is applied to the interior surface 2 (FIG. 1) of the pane of glass in the window 1. More specifically, installation of the Insulation Device A first requires the cleaning of the interior surface 2 of the window 1 before placement of the Insulation Device onto the interior surface. This cleaning is to enhance the ability of the static cling sheet 3 (FIG. 3) to remain in position on the interior surface 2 (FIG. 1) after the installation of the Insulation Device A. Any standard glass cleaning material can be used to clean the interior surface, such as, for example only, a solution of vinegar and water. Any type of glass cleaner can be used as long the glass cleaner selected removes as much debris and oil as possible from the interior surface 2 to prevent the inclusion of such debris from residing between the static cling sheet 3 (FIG. 2) and the interior surface 2 (FIG. 1) in a way that reduces the full contact of the static cling sheet with the interior surface that might result in the static cling sheet eventually losing contact with the interior surface. It is noted that in some embodiments, a small amount of water can be sprayed on the glass at the time the Insulation Device A is being installed to assist in properly positioning the Insulation Device onto the glass surface and smoothing out any bubbles before trimming.

It is understood that the Insulation Device A can be provided in either a sheet format or a roll format. In one embodiment, the Insulation Device A is provided in a sheet format having a width of between about 24 inches and about 36 inches and a height of between about 24 inches and about 36 inches. In a second embodiment, the Insulation Device A is provided in a roll format measuring about 91 cm in height by about 182 cm in length. In either of these formats it is also understood that prior to the installation of the Insulation Device A onto the interior surface 2 (FIG. 1), either the sheet or the roll of the Insulation Device A can be trimmed and fitted to cover the portion of the window 1 that the user wishes to insulate. It is additionally understood that the trimming and fitting of the Insulation Device A can take place either before or after the Insulation Device A has been applied to the interior surface 2 of the window 1. It will be appreciated that installation and use of this embodiment does not require the use of any type of frame or holding device to properly attach or retain the Insulation Device A onto the window 1. Nevertheless, it will be appreciated that when a certain application for the Insulation Device A suggests that a frame or holding device may be needed, it is understood that such alternative embodiments are intended to be within the scope of the claims herein.

It will be appreciated that any number of the above embodiments may be partially or wholly combined to generate yet other embodiments of the present invention.

In the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. An insulation device comprising:
a foam element disposed on a first surface of a static cling element and held in place thereon by an adhesive; and
a removable protective sheet disposed on a second surface of the static cling sheet to generally protect the second surface of the static cling sheet during shipment, storage, and installation of the insulation device.

2. The insulation device of claim 1 wherein the static cling sheet is made from a static cling UV film having a Visible Light Transmission value of at least 25%.

3. The insulation device of claim 2 wherein the static cling UV film has a thickness of between about 0.14 mm and about 0.28 mm.

4. The insulation device of claim 3 wherein the foam element is a polyethylene cross-linked white foam having a thickness of between least about 3.0 mm and a density of between about 2.0 lb to about 3.0 lb per cubic foot.

5. The insulation device of claim 4 wherein the removable protective sheet is made from oriented polypropylene film having a thickness of between about 10 microns and about 40 microns.

6. The insulation device of claim 5 wherein the adhesive is clear polymer adhesive material that can be applied by a sprayer or a roller.

7. The insulation device of claim 6 wherein the insulation device is in sheet format having a width of between about 24 inches and about 36 inches and a height of between about 24 inches and about 36 inches.

8. The insulation device of claim 7 wherein the insulation device is in roll format having a size of about 91 cm in height by about 182 cm in length.

9. A process of providing an insulation device onto a typical window including the steps of:
a manufacturing an insulating device comprising a foam element disposed on a first surface of a static cling element and held in place thereon by an adhesive, and a removable protective sheet disposed on a second surface of the static cling sheet to generally protect the second surface of the static cling sheet during shipment, storage, and installation of the insulation device;
cleaning a surface of a glass pane of the window;
removing the removable protective sheet from the static cling sheet;
positioning the insulating device onto the surface of the glass plane of a window; and
smoothing the insulating device against the glass pane of the window to allow the static cling sheet to have as much contact as possible with the glass pane.

10. The process of claim 9 further comprising the step of trimming the insulation device to fit and match the size and configuration of the insulation device to fit the portion of the window to be insulated.

11. The process of claim 10 wherein the static cling sheet is made from a static cling UV film having a VLT value of at least about 25% and a thickness of between about 0.14 mm and about 0.28 mm.

12. The process of claim 11 wherein the foam element is a polyethylene cross-linked white foam having a thickness of at least 3.0 mm·cm and a density of between about 2.0 lb to about 3.0 lb per cubic foot.

13. The process of claim 12 wherein the removable protective sheet is made from oriented polypropylene film having a thickness of between about 10 microns and about 40 microns.

14. The process of claim 13 wherein the adhesive is a clear polymer adhesive material that can be applied by a sprayer or a roller.

15. The process of claim 14 wherein the insulation device is in sheet format having a width of between about 24 inches and about 36 inches and a height of between about 24 inches and about 36 inches.

16. The process of claim 15 wherein the insulation device is in roll format having a size of about 91 cm in height by about 182 cm in length.
